(19) United States
(12) Patent Application Publication
(10) Pub. No.: US 2012/0281889 A1
(43) Pub. Date: Nov. 8, 2012

(54) Biometric fingerprint control safe

(76) Inventor: Johnson Yang, La Verne, CA (US)

(21) Appl. No.: 13/068,241

(22) Filed: May 5, 2011

(51) Int. Cl. G06K 9/00

(52) U.S. Cl. 382/124

(57) ABSTRACT

A biometric fingerprint control safe includes a cabinet, a lock mechanism, a fingerprint scanning mechanism, and a retention mechanism. The cabinet includes a box body and a top accessing panel folded between an opened position and a closed position. The lock mechanism is provided at the top accessing panel to releasably lock up the top accessing panel at the closed position. The fingerprint scanning mechanism is operatively linked to the lock mechanism for scanning a fingerprint in order to enable the top accessing panel being unlocked. The retention mechanism is provided between the box body and the top accessing panel for applying an upward force against the top accessing panel to retain the top accessing panel at the opened position, such that the top accessing panel must be intentionally pressed down for overcoming said upward force to close the top accessing panel.

### BACKGROUND OF THE PRESENT INVENTION

1. Field of Invention

The present invention relates to a secure lockable device, and more particular to a biometric fingerprint control safe, wherein a top opening wall is released to upwardly fold at its opened position after verifying a fingerprint of a user and is retained by a retention arrangement to prevent the top opening wall being downwardly folded back to its closed position.

2. Description of Related Arts

A safe is a secure lockable cabinet for securing valuable objects, such as jewelries and watches, against theft or damage or for securing firearms, such as guns, to prevent access to unauthorized persons. A conventional safe generally comprises a box with a front accessing door and a locker for locking up the front accessing door at its closed position, wherein the box and the front accessing door may be cast from metal that the safe is relatively heavy for minimizing the portability of the safe. However, the convention safe has several drawbacks.

The objects in the safe cannot be seen when the front accessing door is fully opened. Especially when the safe is placed on the ground level, the user must knee down in order to access the compartment of the safe. Likewise, the drawer type front accessing door is impractical because the front accessing door is relatively heavy.

The locker generally is a numerical lock comprising a key pad, wherein the user must enter a sequence of numbers in order to open the lock. If the key strength is set at lower level, the safe can be unlocked by figuring out a numerical puzzle. If the key strength is set at higher level, the user may forget the sequence of numbers. In case of emergency, the user will take longer time to unlock the front accessing door so as to gain access of the safe.

### SUMMARY OF THE PRESENT INVENTION

The invention is advantageous in that it provides a biometric fingerprint control safe, wherein a top opening wall is released to upwardly fold at its opened position after verifying a fingerprint of a user.

Another advantage of the invention is to provide a biometric fingerprint control safe, wherein the top opening wall is retained by a retention arrangement to prevent the top opening wall being downwardly folded back to its closed position.

Another advantage of the invention is to provide a biometric fingerprint control safe, which facilitates easy and convenient locking or unlocking of the control safe in secure authorizing manner.

Another advantage of the invention is to provide a biometric fingerprint control safe, wherein a finger cavity is formed at the top opening wall for the finger of the user disposing at the finger cavity so as to ensure the fingerprint scanning verification.

Another advantage of the invention is to provide a biometric fingerprint control safe, which does not involve complicated or expensive mechanical components so as to minimize the manufacturing cost of the present invention.

Another advantage of the invention is to provide a biometric fingerprint control safe, which comprises a gyro sensor for measuring the orientation of the control safe so as to prevent an unauthorized access thereof.

Another advantage of the invention is to provide a biometric fingerprint control safe, wherein the operation of the present invention is simple and easy by disposing the finger of the user at the finger cavity for fingerprint verification.

Additional advantages and features of the invention will become apparent from the description which follows, and may be realized by means of the instrumentalities and combinations particular point out in the appended claims.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a biometric fingerprint control safe according to a preferred embodiment of the present invention.

FIG. 2 is a side view of the biometric fingerprint control safe according to the above preferred embodiment of the present invention, illustrating the opened position of the top accessing panel.

FIG. 3 is a side view of the biometric fingerprint control safe according to the above preferred embodiment of the present invention, illustrating the closed position of the top accessing panel.

FIG. 4 illustrates a finger of a user disposing in a finger cavity of the biometric fingerprint control safe according to the above preferred embodiment of the present invention, illustrating the alignment of the transparent scanning window.

FIG. 5 is a front view of the locking mechanism of the biometric fingerprint control safe according to the above preferred embodiment of the present invention.

### DETAILED DESCRIPTION OF THE PREFERRED EMBODIMENT

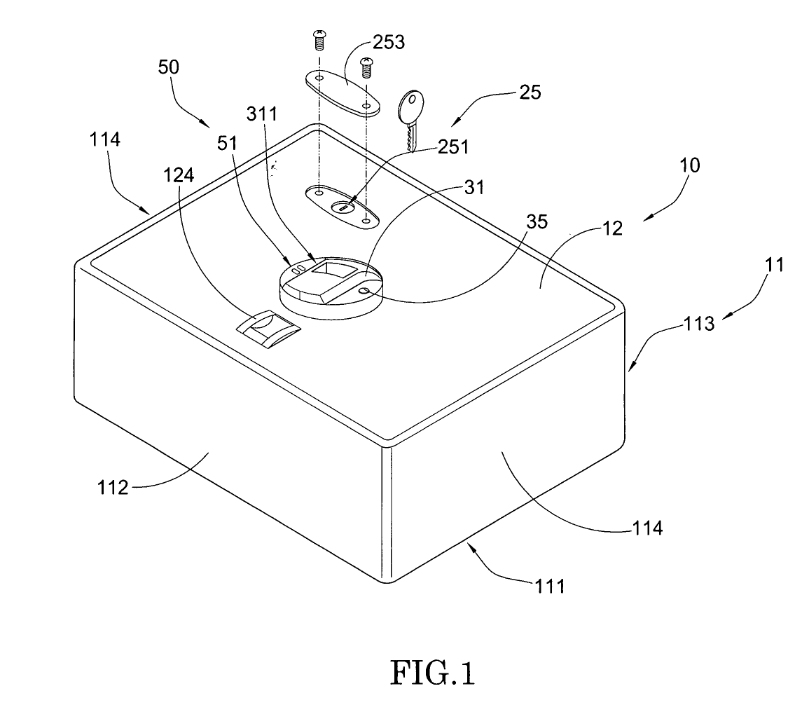

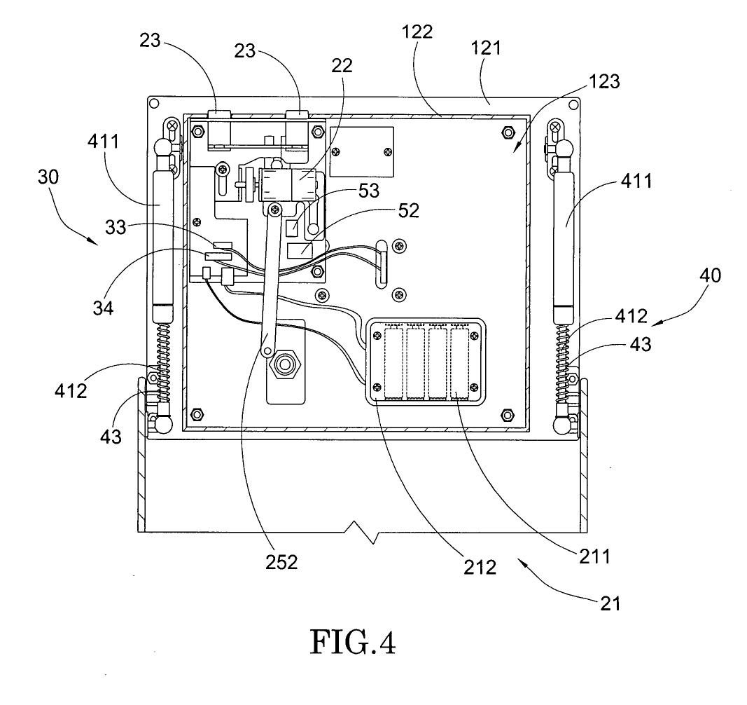

Referring to FIGS. 1 to 5 of the drawings, a biometric fingerprint control safe according to a preferred embodiment of the present invention is illustrated, wherein the biometric fingerprint control safe comprises a cabinet 10, a lock mechanism 20, a fingerprint scanning mechanism 30, and a retention mechanism 40.

The cabinet 10 comprises a box body 11 having a safe compartment 101 with a top opening, and a top accessing panel 12 hinged with the box body 11 to fold between an opened position and a closed position. The box body 11 comprises a bottom panel 111, a front panel 112, a rear panel 113, and two side panels 114 to define the safe compartment 101 within the bottom panel 111, the front panel 112, the rear panel 113, and the side panels 114.

The lock mechanism 20 is provided at the top accessing panel 12 to releasably lock up the top accessing panel 12 at the closed position, wherein the lock mechanism 20 is actuated to release the top accessing panel 12 such that the top accessing panel 12 can be folded from the closed position to the opened position.

The fingerprint scanning mechanism 30 is operatively linked to the lock mechanism 20 for scanning a fingerprint of a user and arranged in such a manner that when the fingerprint is detected in an authorized manner, the lock mechanism 20 is unlocked to enable the top accessing panel 12 being folded from the closed position to the opened position.

The retention mechanism 40 is provided between the box body 11 and the top accessing panel 12 for applying an upward force against the top accessing panel 12 to retain the top accessing panel 12 at the opened position, such that the top accessing panel 12 must be intentionally pressed down for overcoming the upward force to enclose the safe compartment 101.

According to the preferred embodiment, the top accessing panel 12 is pivotally hinged with the box body 11, wherein a rear edge of the top accessing panel 12 is pivotally connected to the rear panel 113 such that the top accessing panel 12 is adapted to pivotally fold between the opened position and the closed position. At the opened position, the top accessing panel 12 is upwardly and pivotally folded to expose the safe compartment 101. At the closed position, the top accessing panel 12 is downwardly and pivotally folded at the top opening of the box body 11 to enclose the safe compartment 101 thereof.

The top accessing panel 12 comprises a top covering wall 121 and a top protecting housing 122 mounted underneath the top covering wall 121 to define a protection cavity 123 therebetween, wherein the lock mechanism 20 and the fingerprint scanning mechanism 30 are protected within the protection cavity 123. The top accessing panel 12 further comprises an actuation handle 124 provided on the top side of the top covering wall 121, wherein the actuation handle 124 has an actuation indention for the user to pivotally lift up the top accessing panel 12 by the finger of the user.

Accordingly, the top protecting housing 122 has a size smaller than a size of the top covering wall 121, wherein the top protecting housing 122 is mounted at the bottom surface of the top protecting housing 122 to define a peripheral portion of the top covering wall 121 at the bottom surface thereof.

The lock mechanism 20 comprises a power source 21 supported at the bottom surface of the top protecting housing 122, i.e. the bottom surface of the top accessing panel 12, a power generator 22 received within the protection cavity 123 and electrically linked to the power source 21, at least a locking latch 23 driven by the power generator 22 to lock up the top accessing panel 12 at the front panel 112 of the box body 11.

The power source 21 is activated in responsive to the fingerprint scanning mechanism 30. The power source 21 comprises a battery compartment 211 supported by the top protecting housing 122 and a compartment cover 212 detachably covering the battery compartment 211. It is worth mentioning that the compartment cover 212 can be detached from the top protecting housing 122 for replacing batteries in the battery compartment 211 when the top accessing panel 12 is folded at the opened position. In other words, when the top accessing panel 12 is folded and locked at the closed position, the power source 21 cannot be accessed.

The power generator 22 is embodied as an electric motor protected within the protection cavity 123 and powered by the power source 21, wherein the power generator 22 comprises a driving shaft operatively connected to the locking latch 23 to drive the locking latch 23 moving to lock and unlock the top accessing panel 12.

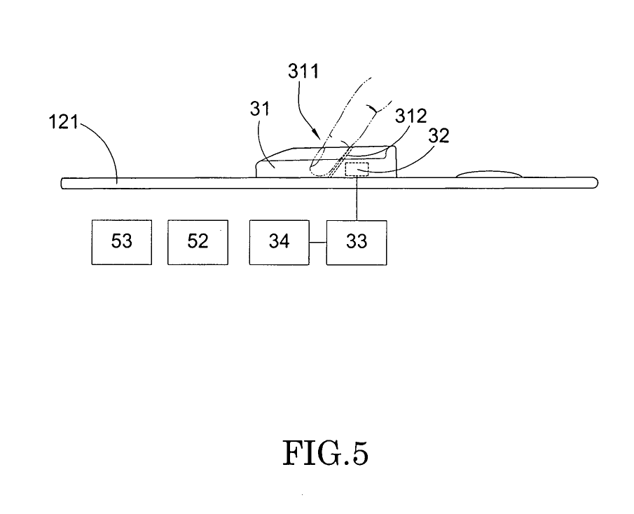

As shown in FIG. 5, two locking latches 23 are actuated by the power generator 22 synchronically. The top protecting housing 122 has two through slots spacedly formed at a front rim thereof to align with the locking latches 23 respectively. Accordingly, when the locking latches 23 are moved at an unlocked position, the locking latches 23 are supported within the protecting cavity 123. When the locking latches 23 are moved at a locked position, the head portions of the locking latches 23 are extended out of the protection cavity 123 through the through slots respectively at the same time to engage with the front panel 112 of the box body 11. The locking mechanism 20 further comprises a locking member 24 provided at the inner surface of the front panel 112 of the box body 11 to engage with the head portions of the locking latches 23.

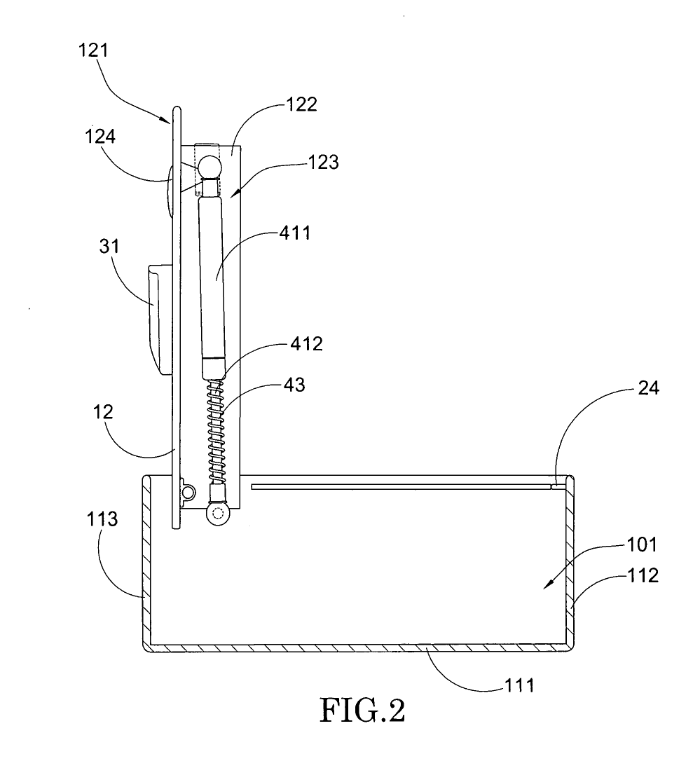

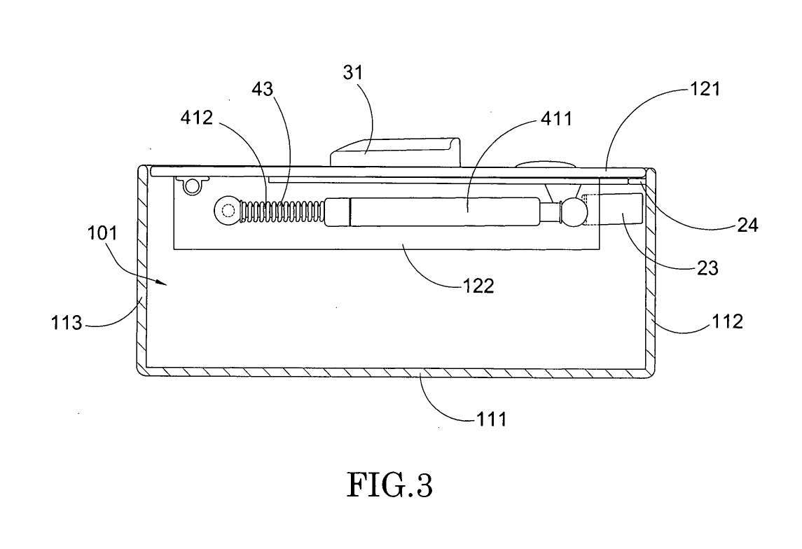

As shown in FIGS. 2 and 3, the locking member 24 is embodied as an elongated locking bar coupled at the inner surface of the front panel 112 of the box body 11 such that when the locking latches 23 are actuated toward the front panel 112, the head portions of the locking latches 23 are extended out of the protection cavity 123 through the through slots respectively at the same time to engage with the locking member 24 at the front panel 112 of the box body 11. It is appreciated that the locking member 24 can be embodied as two socket members coupled at the inner surface of the front panel 112 of the box body 11 such that the head portions of the locking latches 23 are alignedly extended to engage with the sockets of the socket members respectively.

The lock mechanism 20 further comprises a key lock assembly 25 for releasing the top accessing panel 12, wherein the key lock assembly 25 has a key slot 251 formed on the top surface of the top accessing panel 12 and a key actuation unit 252 operatively linked to the locking latches 23 in such a manner that when a corresponding key is inserted into the key slot 251, the key is adapted to actuate the key actuation unit 252 to move the locking latches 23 between the locked position and the unlocked position. In other words, the power generator 22 can be overwritten by the key lock assembly 25 such that the user is able to unlock the top accessing panel 12 in case the fingerprint scanning mechanism 30 is not working properly. Preferably, a key slot cover 253 is detachably coupled on the top surface of the top accessing panel 12 to cover the key slot 251 thereon.

The fingerprint scanning mechanism 30, which is also powered by the power supply 21, comprises an actuation housing 31 provided on the top surface of the top accessing panel 12, wherein the actuation housing 31 has an indented finger cavity 311 and comprises a transparent scanning window 312 supported within the finger cavity 311 and arranged in such a manner that when a finger of a user disposes within the finger cavity 311, the finger of the user aligns with the transparent scanning window 312 for being scanned.

According to the preferred embodiment, the fingerprint scanning mechanism 30 further comprises a fingerprint scanning head 32 supported within the actuation housing 31 to align with the transparent scanning window 312 such that when the finger of the user places on the transparent scanning window 312, the fingerprint scanning head 32 is adapted to scan the fingerprint of the user and to transmit the fingerprint image as a digit data.

The finger cavity 311 has a predetermined depth for the finger of the user fitting thereat, wherein when the finger tip of the user contacts with the bottom wall of the finger cavity 311, the transparent scanning window 312 is aligned with the finger of the user for scanning the fingerprint thereof. In other words, the finger cavity 311 forms a fingerprint alignment for the user to align the finger at the transparent scanning window 312 so as to ensure the fingerprint of the user being precisely scanned.

In addition, the transparent scanning window 312 is inclinedly supported within the finger cavity 311 such that the finger of the user is able to easily place on the transparent scanning window 312. Therefore, the user is able to simply place the finger within the finger cavity 311 until the finger tip reaches the bottom wall of the finger cavity 311 so as to physically align the fingerprint on the transparent scanning window 312 without bending the finger. It is worth mentioning that the user is able to reach and place finger within the finger cavity 311 at dark by physically contacting the actuation housing 31.

The fingerprint scanning mechanism 30 further comprises a memory unit 33 protected within the protection cavity 123 for storing a fingerprint of one or more authorized users in a digital format and a verification unit 34 operatively linked to the memory unit 33 for actuating the locking mechanism 20 to unlock the top accessing panel 12 upon the fingerprint scanned at the transparent scanning window 312 matching with the fingerprint of one or more authorized users stored in the memory unit 33.

Accordingly, the user is able to store multiple fingerprints data in the memory unit 33 such that more than one authorized users can be access and unlock the locking mechanism 20. Or, multiple fingerprints data in the memory unit 33 can be set by different fingers of the user such that the user is able to use one of the fingers for scanning.

The verification unit 34 comprises a verification circuit protected within the protection cavity 123, wherein the verification circuit of the verification unit 34 is operatively linked between the fingerprint scanning head 32 and the memory unit 33. When the verification unit 34 receives the fingerprint image from the fingerprint scanning head 32, the verification unit 34 will compare the fingerprint image and the stored fingerprint date from the memory unit 33. When the fingerprint image matches the stored fingerprint date, the verification unit 34 will send an actuation signal to the locking mechanism 20 in order to activate the power generator 22. It is worth mentioning that the verification unit 34 forms a control unit to activate the locking mechanism 20 by means of the authorized fingerprint scanning.

The fingerprint scanning mechanism 30 further comprises an operation button 35 provided on the actuation housing 31 at a position adjacent to the finger cavity 311 for activating the power supply 21. Accordingly, when the operation button 35 is pressed, the fingerprint scanning head 32 is automatically activated for ready to scan. Once the finger of the user places at the finger cavity 311 on the transparent scanning window 312, the fingerprint scanning head 32 will scan the fingerprint of the user. It is worth mentioning that the fingerprint scanning head 32 will be automatically activated for a predetermined activation time, such as five seconds, after the operation button 35 is pressed. In other words, after the predetermined activation time, the fingerprint scanning head 32 will be automatically deactivated. Therefore, the user must press the operation button 35 again to re-activate the fingerprint scanning head 32 when the activation time is over.

According to the preferred embodiment, the retention mechanism 40 comprises one or more hydraulic arms 41, preferably two hydraulic arms 41, for applying the upward force against the top accessing panel 12 to retain the top accessing panel 12 at the opened position so as to prevent the top accessing panel 12 being dropped down to the closed position accidentally. Accordingly, each of the hydraulic arms 41 has an upper end coupled at the top accessing panel 12 and a lower end coupled at an interior side of the box body 11.

As shown in FIG. 5, the upper end of the hydraulic arm 41 is coupled at the bottom side of the top covering wall 121 at a position aside from the top protection housing 122. In other words, the upper end of the hydraulic arm 41 is coupled at the peripheral portion of the top covering wall 121 at the bottom side thereof.

The lower end of the hydraulic arm 41 is coupled at an inner sidewall of the box body 11. In particular, the lower end of the hydraulic arm 41 is coupled at the inner sidewall of the side panel 114 of the box body 11.

According to the preferred embodiment, two hydraulic arms 41 are coupled at two side portions of the cabinet 10 respectively, wherein the upper ends of the hydraulic arms 41 are coupled at two side portions of the top accessing panel 12 while the lower ends of the hydraulic arms 41 are coupled at the side panels 114 of the box body 11, such that the top accessing panel 12 can be pivotally lifted up or dropped down in a balancing manner.

Each of the hydraulic arms 41 has an upper tubular piston cylinder 411 defining the upper end to couple at the top accessing panel 12 and a piston arm 412 defining the lower end to couple at the side panel 114, wherein the piston arm 412 is slidably coupled with the piston cylinder 411 by means of hydraulic force. Therefore, when the top accessing panel 12 is pivotally lifted up, the piston cylinder 411 and the piston arm 412 are slid away from each other to lengthen the distance between the upper and lower ends. When the top accessing panel 12 is pivotally dropped down, the piston cylinder 411 and the piston arm 412 are slid toward each other to reduce the distance between the upper and lower ends. It is worth mentioning that the hydraulic force of the hydraulic arm 41 is the upward pushing force to retain the top accessing panel 12 at the opened position. In other words, when the top accessing panel 12 is pivotally moved from the opened position to the closed position, the user must intentionally apply a downward closing force to overcome the hydraulic force of the hydraulic arm 41.

According to the preferred embodiment, the retention mechanism 40 further comprises a resilient element 43 coupled with the each of the hydraulic arm 41 to apply an initial upward force at the top accessing panel 12 to enable the top accessing panel 12 being pivotally lifted easily. The resilient element 43 is a compression spring coaxially coupled at the piston arm 412 for applying a spring force against the piston cylinder 411, wherein when the top accessing panel 12 is pivotally moved from the opened position to the closed position to reduce the distance between the upper and lower ends of the hydraulic arm 41, the resilient element 43 will be forced to compress so as to restore a spring force at the resilient element 43. When the top accessing panel 12 is pivotally moved to the opened position from the closed position initially, the restored spring force will be transmitted to the top accessing panel 12 to initially and upwardly push thereat such that the top accessing panel 12 can be easily lifted up. It is worth mentioning that the spring force of the resilient element 43 will also form as a resistance to prevent the top accessing panel 12 from being pivotally dropped down accidentally.

The biometric fingerprint control safe of the present invention further comprises an indicating unit 50 for indicating the status of the cabinet 10, wherein the indicating unit 50 is operatively linked to the locking mechanism 20 and the fingerprint scanning mechanism 30. According to the preferred embodiment, the indicating unit 50 comprises a plurality of light indicators 51 provided at the actuation housing 31 and arranged in such a manner that when the operation button 35 is pressed to activate the fingerprint scanning head 32, one of the light indicators 51 will generate a light effect to indicate the activation of the fingerprint scanning head 32. When the fingerprint image scanned by the fingerprint scanning head 32 matches the stored fingerprint date in the memory unit 33, another light indicator 51 will generate a corresponding light effect to indicate the locking mechanism 30 being locked. If the fingerprint image scanned by the fingerprint scanning head 32 is an unauthorized fingerprint image, i.e. the fingerprint image scanned not matching the stored fingerprint date, the light indicator 51 will generate a corresponding light effect to indicate the unauthorized access of the cabinet 10. In other words, the light indicators 51 are arranged for indicating the activation of the fingerprint scanning mechanism 30 and the locking status of the locking mechanism 20 so as to indicate the accessible status of the top accessing panel 12.

The indicating unit 50 further comprises a sound generator 52 protected within the protection cavity 123 for sound generation corresponding to the light effect of the light indicators 51. Therefore, the indicating unit 50 can generate both light and sound effect as an indication of the status of the cabinet 10.

The indicating unit 50 further comprises an alert unit 53 for generating an alert signal when the cabinet 10 is being unauthorized accessed, wherein the alert unit 53 is operatively linked to the sound generator 52 to generate an alerting sound effect when the cabinet 10 is being unauthorized accessed. Preferably, the alert unit 53 comprises a gyro sensor for measuring the orientation of the control safe so as to prevent an unauthorized access thereof. The gyro sensor is supported by the top accessing panel 12 at a position within the protection cavity 123 to measure the orientation of the top accessing panel 12, wherein the gyro sensor is automatically activated when the locking mechanism 20 is actuated at a locked status. Therefore, when the cabinet 10 is moved at the locked status, the gyro sensor will send an alert signal to the sound generator 52. Once the locking mechanism 20 is unlocked, the gyro sensor will be automatically deactivated.

In order to operate the biometric fingerprint control safe of the present invention, the user is able to pre-store the fingerprint in the memory unit 33 by pressing the operation button 35 and by placing the finger of the user at the transparent scanning window 312. Therefore, the fingerprint scanning head 32 will scan the fingerprint of the user and the scanned fingerprint will be stored in the memory unit 33.

In order to gain access of the biometric fingerprint control safe of the present invention, the user is able to press operation button 35 and to place the finger of the user at the transparent scanning window 312. The fingerprint scanning head 32 will be automatically activated to scan the fingerprint of the user. When the verification unit 34 receives the fingerprint image from the fingerprint scanning head 32, the verification unit 34 will compare the fingerprint image and the stored fingerprint date from the memory unit 33. When the fingerprint image matches the stored fingerprint date, the verification unit 34 will send an actuation signal to the locking mechanism 20 in order to unlock the top accessing panel 12.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A biometric fingerprint control safe, comprising:
a cabinet which comprises a box body having a safe compartment therein, and a top accessing panel hinged with said box body to fold between an opened position that said top accessing panel is upwardly folded to expose said safe compartment and a closed position that said top accessing panel is downwardly folded to enclose said safe compartment;
a lock mechanism provided at said top accessing panel to releasably lock up said top accessing panel at said closed position; and
to a fingerprint scanning mechanism operatively linked to said lock mechanism for scanning a fingerprint, wherein said fingerprint scanning mechanism is supported at said top accessing panel and is arranged in such a manner that when said fingerprint is detected in an authorized manner, said lock mechanism is unlocked to enable said top accessing panel being folded from said closed position to said opened position.

2. The biometric fingerprint control safe, as recited in claim 1, further comprising a retention mechanism provided between said box body and said top accessing panel for applying an upward force against said top accessing panel to retain said top accessing panel at said opened position, such that said top accessing panel must be intentionally pressed down for overcoming said upward force to enclose said safe compartment.

3. The biometric fingerprint control safe, as recited in claim 2, wherein said top accessing panel comprises a top covering wall and a top protecting housing mounted underneath said top covering wall to define a protection cavity therebetween, wherein said lock mechanism and said fingerprint scanning mechanism are protected within said protection cavity.

4. The biometric fingerprint control safe, as recited in claim 2, wherein said retention mechanism comprises one or more hydraulic arms for applying said upward force against said top accessing panel, wherein each of said hydraulic arms has an upper end coupled at said top accessing panel and a lower end coupled at an interior side of said box body.

5. The biometric fingerprint control safe, as recited in claim 3, wherein said retention mechanism comprises one or more hydraulic arms for applying said upward force against said top accessing panel, wherein each of said hydraulic arms has an upper end coupled at said top accessing panel and a lower end coupled at an interior side of said box body.

6. The biometric fingerprint control safe, as recited in claim 5, wherein said upper end of said hydraulic arm is coupled at a bottom side of said top covering wall and said lower end of said hydraulic arm is coupled at an inner sidewall of said box body.

7. The biometric fingerprint control safe, as recited in claim 1, wherein said fingerprint scanning mechanism comprises an actuation housing provided on a top surface of said top accessing panel, wherein said actuation housing has a finger cavity indented thereon and comprises a transparent scanning window supported within said finger cavity and arranged in such a manner that when a finger of a user disposes within said finger cavity, the finger of the user aligns with said transparent scanning window for being scanned.

8. The biometric fingerprint control safe, as recited in claim 3, wherein said fingerprint scanning mechanism comprises an actuation housing provided on a top surface of said top accessing panel, wherein said actuation housing has a finger cavity indented thereon and comprises a transparent scanning window supported within said finger cavity and arranged in such a manner that when a finger of a user disposes within said finger cavity, the finger of the user aligns with said transparent scanning window for being scanned.

9. The biometric fingerprint control safe, as recited in claim 6, wherein said fingerprint scanning mechanism comprises an actuation housing provided on a top surface of said top accessing panel, wherein said actuation housing has a finger cavity indented thereon and comprises a transparent scanning window supported within said finger cavity and arranged in such a manner that when a finger of a user disposes within said finger cavity, the finger of the user aligns with said transparent scanning window for being scanned.

10. The biometric fingerprint control safe, as recited in claim 7, wherein said transparent scanning window is inclinedly supported within said finger cavity having a to predetermined depth and is arranged in such a manner that when a finger tip of the contacts at a bottom wall of said finger cavity, said transparent scanning window is aligned with the finger of the user for scanning the fingerprint thereof.

11. The biometric fingerprint control safe, as recited in claim 8, wherein said transparent scanning window is inclinedly supported within said finger cavity having a predetermined depth and is arranged in such a manner that when a finger tip of the contacts at a bottom wall of said finger cavity, said transparent scanning window is aligned with the finger of the user for scanning the fingerprint thereof.

12. The biometric fingerprint control safe, as recited in claim 9, wherein said transparent scanning window is inclinedly supported within said finger cavity having a predetermined depth and is arranged in such a manner that when a finger tip of the contacts at a bottom wall of said finger cavity, said transparent scanning window is aligned with the finger of the user for scanning the fingerprint thereof.

13. The biometric fingerprint control safe, as recited in claim 10, wherein said fingerprint scanning mechanism further comprises a memory unit protected within said protection cavity for storing a fingerprint of one or more authorized users and a verification unit operatively linked to said memory unit for actuating said locking mechanism to unlock said top accessing panel upon said fingerprint scanned at said transparent scanning window matching with said fingerprint of one or more authorized users stored in said memory unit.

14. The biometric fingerprint control safe, as recited in claim 11, wherein said fingerprint scanning mechanism further comprises a memory unit protected within said protection cavity for storing a fingerprint of one or more authorized users and a verification unit operatively linked to said memory unit for actuating said locking mechanism to unlock said top accessing panel upon said fingerprint scanned at said transparent scanning window matching with said fingerprint of one or more authorized users stored in said memory unit.

15. The biometric fingerprint control safe, as recited in claim 12, wherein said fingerprint scanning mechanism further comprises a memory unit protected within said protection cavity for storing a fingerprint of one or more authorized users and a verification unit operatively linked to said memory unit for actuating said locking mechanism to unlock said top accessing panel upon said fingerprint scanned at said transparent scanning window matching with said fingerprint of one or more authorized users stored in said memory unit.

16. The biometric fingerprint control safe, as recited in claim 1, further comprising an indicating unit operatively linked to said locking mechanism and said fingerprint scanning mechanism for indicating a status of said cabinet.

17. The biometric fingerprint control safe, as recited in claim 6, further comprising an indicating unit operatively linked to said locking mechanism and said fingerprint scanning mechanism for indicating a status of said cabinet.

18. The biometric fingerprint control safe, as recited in claim 15, further comprising an indicating unit operatively linked to said locking mechanism and said fingerprint scanning mechanism for indicating a status of said cabinet.

19. The biometric fingerprint control safe, as recited in claim 1, further comprising a gyro sensor supported by said top accessing panel for measuring an orientation of said top accessing panel so as to prevent an unauthorized access thereof, wherein said gyro sensor is automatically activated when said locking mechanism is actuated at a locked status and is automatically deactivated when said locking mechanism is actuated at an unlocked status.

20. The biometric fingerprint control safe, as recited in claim 6, further comprising a gyro sensor supported by said top accessing panel for measuring an orientation of said top accessing panel so as to prevent an unauthorized access thereof, wherein said gyro sensor is automatically activated when said locking mechanism is actuated at a locked status and is automatically deactivated when said locking mechanism is actuated at an unlocked status.

21. The biometric fingerprint control safe, as recited in claim 18, further comprising a gyro sensor supported by said top accessing panel for measuring an orientation of said top accessing panel so as to prevent an unauthorized access thereof, wherein said gyro sensor is automatically activated when said locking mechanism is actuated at a locked status and is automatically deactivated when said locking mechanism is actuated at an unlocked status.
